(19) United States
(12) Patent Application Publication
(10) Pub. No.: US 2025/0063058 A1
(43) Pub. Date: Feb. 20, 2025

(54) APT DETECTION METHOD AND SYSTEM BASED ON CONTINUOUS-TIME DYNAMIC HETEROGENEOUS GRAPH NETWORK

(71) Applicants: NANJING NARI INFORMATION & COMMUNICATION TECHNOLOGY CO., LTD., Nanjing (CN); NARI GROUP CORPORATION, Nanjing (CN)

(72) Inventors: Weiyong Yang, Nanjing (CN); Peng Gao, Nanjing (CN); Wei Liu, Nanjing (CN); Xingshen Wei, Nanjing (CN); Haotian Zhang, Nanjing (CN); Yongjian Cao, Nanjing (CN); Shishun Zhu, Nanjing (CN); Longyun Qi, Nanjing (CN); Jian Zhou, Nanjing (CN); Zengzhou Ma, Nanjing (CN); Yibin Huang, Nanjing (CN); Ke Li, Nanjing (CN); Weibo Zheng, Nanjing (CN); Qiuhan Tian, Nanjing (CN); Yiming Zhu, Nanjing (CN); Huishui Li, Nanjing (CN); Yongming Cao, Nanjing (CN); Nannan Guo, Nanjing (CN); Chao Wu, Nanjing (CN); Yifan Gu, Nanjing (CN)

(21) Appl. No.: 18/937,004

(22) Filed: Nov. 4, 2024

Related U.S. Application Data
(63) Continuation-in-part of application No. PCT/CN2023/140787, filed on Dec. 21, 2023.

(30) Foreign Application Priority Data
Dec. 1, 2022 (CN) 202211526331.X

(51) Int. Cl. H04L 9/40; G06N 7/01

(52) U.S. Cl. CPC H04L 63/1425; G06N 7/01; H04L 63/1416

(57) ABSTRACT

Disclosed are an advanced persistent threat (APT) detection method and system based on a continuous-time dynamic heterogeneous graph network (CDHGN). The method includes: selecting network interaction event data, extracting entities from the network interaction event data as source nodes and target nodes, extracting an interaction event occurring between a source node and a target node as an edge, and determining a type and an attribute of a node, a type and an attribute of the edge, and a moment at which an interaction event occurs, to obtain a continuous-time dynamic heterogeneous graph; converting each type of edge in the continuous-time dynamic heterogeneous graph into a vector by a CDHGN encoder, to obtain an embedding representation by a CDHGN decoder to obtain a detection result of whether each type of edge is an abnormal edge, to intercept an APT attack.

### CROSS REFERENCE TO RELATED APPLICATIONS

The present application is a Continuation-In-Part application of PCT Application No. PCT/CN2023/140787 filed on Dec. 21, 2023, which claims the benefit of Chinese Patent Application No. 202211526331.X filed on Dec. 1, 2022. All the above are hereby incorporated by reference in their entirety.

### TECHNICAL FIELD

The present disclosure pertains to the field of cyber security, and specifically relates to an advanced persistent threat (APT) detection method and system based on a continuous-time dynamic heterogeneous graph network (CDHGN).

### BACKGROUND

In recent years, advanced persistent threats (APT) as the representative of network attacks against power systems frequently occur. APT attacks are long-term and persistent network attacks on specific targets by organizations with high-level expertise and rich resources through complex attack means. In an APT attack, an attacker first bypasses a border protection and invades the network in various manners; then uses a failed host as a “bridge” to gradually obtain higher network permission and continuously spy on target data; and finally, the attacker destroys the system and deletes traces of malicious behaviors. Compared with a traditional network attack mode, the APT attack has the feature of “spatial-temporal sparsity”, that is, “Low-and-Slow”. This makes it very difficult to identify APT attacks, resulting in significant damage.

Detection technologies for APT attacks can be classified into feature detection (misuse detection) and anomaly detection. In the feature detection, a feature code of network intrusion is defined, and it is determined, based on pattern matching, whether entity behaviors such as traffic, user operations, and system calls in a network system include an intrusion behavior. Such methods accumulate many effective rules based on expert knowledge and experience, and can efficiently and accurately detect known attack behaviors, but cannot effectively detect unknown attack behaviors. An anomaly detection method based on statistical machine learning trains a baseline model by collecting behavior data of various entities in the network system, and when a deviation from the baseline reaches a threshold, it is determined as a network attack behavior. Main advantages of such an anomaly detection method are that it has a generalization capability and can detect an unknown attack behavior outside a feature library. However, according to different downstream tasks, a detection result depends heavily on quality of feature engineering based on artificial experience. In addition, an APT detection error rate is high. The main reasons are that the APT attack has the feature of “spatial-temporal sparsity”, and the attacker lurks for a long time. In addition, behaviors of users and hosts in a plurality of dimensions are involved, with few and irregular traces of various behaviors. As a result, it is difficult to accurately capture abnormal behaviors in massive normal behavior data.

A “graph” may more naturally and fully represent a dynamic relationship between a subject (for example, a user) and an object (for example, a Personal Computer (PC)) in non-Euclidean space of the computer network (for example, logoff after logon). In recent years, an anomaly detection method based on a graph neural network (GNN) has received wide attention. In this method, a subject and an object in the network and a relationship between them are first modeled in a “graph” manner, then a GNN model is input for graph representation learning to obtain embedding representation information of the graph, and then attack detection, tracing and prediction tasks are completed by a classification algorithm. Currently, a GNN-based detection method generally represents a dynamic graph by sequences of graph snapshots. However, this discrete dynamic graph manner cannot fully characterize attributes of the computer network, since real interaction events of the computer network are typically performed (edges may occur anytime) and evolved (node attributes are constantly updated) in a continuous-time dynamic graph.

Therefore, currently, the performance of the graph neural network-based method is still limited in terms of APT detection. Essentially, various detection models have challenges of insufficient information extraction capability for embedding information of network entities and interaction events, which are mainly reflected in the following three aspects: 1) Because of sparse distribution of APT attack behaviors in time and space, a discrete graph snapshot sequence indicates that some important “bridge” interaction events may be lost, thereby reducing detection performance; 2) The network entities and behaviors are multi-dimensional and heterogeneous, and occur continuously, lacking complete context information of interaction events between entities, which makes it difficult to identify malicious attacks; 3) The detection of a full graph of a whole network topology based on the discrete graph snapshot method not only requires large memory space for real-time stream analysis, but also leads to coarse-grained results and lack of context information.

### SUMMARY

To resolve the foregoing problem, the present disclosure provides an end-to-end APT attack detection method and system based on a continuous-time dynamic heterogeneous graph network (CDHGN). The core idea is to integrate independent heterogeneous memories and attention mechanisms of “nodes” and “edges” into information propagation processes of nodes and edges in the graph, and perform deep correlation in time dimension and space dimension on interaction information between computer network entities carried in a continuous-time dynamic graph, so as to capture an abnormal edge (an abnormal interaction event).

The following technical solutions are adopted in the present disclosure.

According to one aspect, the present disclosure provides an APT detection method based on a CDHGN, including:
selecting network interaction event data in a specified time period, extracting entities from the network interaction event data as source nodes and target nodes, extracting an interaction event occurring between a source node and a target node as an edge, and determining a type and an attribute of a node, a type and an attribute of the edge, and a moment at which an interaction event occurs, to obtain a continuous-time dynamic heterogeneous graph;
converting each type of edge in the continuous-time dynamic heterogeneous graph into a vector by a CDHGN encoder, to obtain an embedding representation of each type of edge; and
decoding the embedding representation of each type of edge in the continuous-time dynamic heterogeneous graph by a CDHGN decoder to obtain a detection result of whether each type of edge is an abnormal edge, so as to intercept an APT attack according to the abnormal edge.

Further, the continuous-time dynamic heterogeneous graph is represented as a ten-tuple set and denoted as {(src,e,dst,t,src_type,dst_type,edge_type,src_feats,dst_feats,edge_feats)}, where
src represents a source node, and dst represents a target node; e represents an edge connecting a source node to a target node; t represents a moment at which an interaction event occurs between a source node and a target node; src_type, dst_type, and edge_type are respectively a type of a source node, a type of a target node, and a type of an edge; and src_feats, dst_feats, and edge_feats are respectively an attribute of a source node, an attribute of a target node, and an attribute of an edge.

Further, the converting each type of edge in the continuous-time dynamic heterogeneous graph into a vector by a CDHGN encoder, to obtain an embedding representation of each type of edge includes:
for each edge in the continuous-time dynamic heterogeneous graph, separately generating, by a message function according to a time interval between a current moment and a previous moment at which an interaction event occurs, an edge connecting a source node to a target node, and embedding representation memories of the source node and the target node at the previous moment at which an interaction event occurs, message values corresponding to each source node and each target node at the current moment at which an interaction event occurs;
separately performing, by an aggregation function, message aggregation on message values corresponding to all source nodes and target nodes in this batch at a current moment at which each interaction event occurs, to separately obtain aggregated message values of each source node and each target node at the current moment at which an interaction event occurs;
after an interaction event occurs between a source node and a target node, updating, according to the aggregated message values of each source node and each target node at the current moment at which an interaction event occurs and the embedding representation memories of each source node and each target node at the previous moment at which an interaction event occurs, embedding representation memories of each source node and each target node in this batch at the current moment at which an interaction event occurs;
performing memory fusion on the updated embedding representation memories of each source node and each target node in this batch at the current moment with vector representations with node attributes of each source node and each target node in this batch, to obtain embedding representations that include time context information and that are of each source node and each target node in this batch;
calculating an attention score of each node according to the embedding representations that include time context information and that are of each source node and each target node, an edge between each source node and each target node, a preset node attention weight matrix, and a preset edge attention weight matrix;
extracting a multi-head message value of each source node corresponding to a target node by a message transfer function according to a preset edge message weight matrix and a preset node message weight matrix, and concatenating to generate a message vector of each source node; and aggregating the message vector of each source node according to the attention score of each node, to obtain embedding representations that include space context information and that are of each source node and each target node, and transferring the embedding representations that include space context information to the target node; and
merging an embedding representation that includes time context information and that is of a source node on each edge and an embedding representation that includes space context information and that is of a target node, to obtain, according to a type of an edge, an embedding representation that includes time and space context information and that is of each type of edge.

Further, when message aggregation is performed:
if a same source node is connected to different target nodes at the same time, the aggregation function takes an average value of all message values;
if a same source node is connected to a same target node at different times, the aggregation function retains only a message value of a given node at a latest moment, where the given node is a source node; or
if a same source node is connected to different target nodes at different times, the aggregation function is set to an average value of all message values.

Further, a method for training the CDHGN decoder includes: inputting an embedding representation of each type of edge, performing sample labeling on the embedding representation of each type of edge to obtain a sample label, and performing supervised training on the CDHGN encoder and the CDHGN decoder to determine whether an embedding representation of an edge between a source node and a target node at a time point is abnormal.

Further, the CDHGN decoder uses a binary cross-entropy loss function and is defined as:

L(\tilde{y}ᵢ(t),yᵢ(t))=−(yᵢ(t)·log(\tilde{y}ᵢ(t))+(1−yᵢ(t))·log(1− [symbol] (t))), where
\tilde{y}ᵢ(t) represents a result of determining that an i^{th} edge at a moment t output by the CDHGN decoder is abnormal, and yᵢ(t) represents a sample label value corresponding to the i^{th} edge.

According to a second aspect, the present disclosure provides an APT detection system based on a CDHGN, including a graph constructing module, a network encoder, and a network decoder.

The graph constructing module is configured to: select network interaction event data in a specified time period, extract entities from the network interaction event data as source nodes and target nodes, extract an interaction event occurring between a source node and a target node as an edge, and determine a type and an attribute of a node, a type and an attribute of the edge, and a moment at which an interaction event occurs, to obtain a continuous-time dynamic heterogeneous graph.

The network encoder is configured to convert each type of edge in the continuous-time dynamic heterogeneous graph into a vector, to obtain an embedding representation of each type of edge.

The network decoder is configured to decode the embedding representation of each type of edge in the continuous-time dynamic heterogeneous graph to obtain a detection result of whether each type of edge is an abnormal edge, so as to intercept an APT attack according to the abnormal edge.

Further, the system further includes a training module, and the training module is configured to train the network encoder and the network decoder.

Further, the network encoder includes a node time memory network and a node space attention network; the node time memory network includes a first message module, a first aggregation module, a memory update module, and a memory fusion module; and the node space attention network includes an attention module, a second message module, and a second aggregation module.

The first message module is configured to: for each edge in the continuous-time dynamic heterogeneous graph, separately generate, by a message function according to a time interval between a current moment and a previous moment at which an interaction event occurs, an edge connecting a source node to a target node, and embedding representation memories of the source node and the target node at the previous moment at which an interaction event occurs, message values corresponding to each source node and each target node at the current moment at which an interaction event occurs.

The first aggregation module is configured to separately perform, by an aggregation function, message aggregation on message values corresponding to all source nodes and target nodes in this batch at a current moment at which each interaction event occurs, to separately obtain aggregated message values of each source node and each target node at the current moment at which an interaction event occurs.

The memory update module is configured to: after an interaction event occurs between a source node and a target node, update, according to the aggregated message values of each source node and each target node at the current moment at which an interaction event occurs and the embedding representation memories of each source node and each target node at the previous moment at which an interaction event occurs, embedding representation memories of each source node and each target node in this batch at the current moment at which an interaction event occurs.

The memory fusion module is configured to: perform memory fusion on the updated embedding representation memories of each source node and each target node in this batch at the current moment with vector representations with node attributes of each source node and each target node in this batch, to obtain embedding representations that include time context information and that are of each source node and each target node in this batch.

The attention module is configured to calculate an attention score of each node according to the embedding representations that include time context information and that are of each source node and each target node, an edge between each source node and each target node, a preset node attention weight matrix, and a preset edge attention weight matrix.

The second message module is configured to: extract a multi-head message value of each source node corresponding to a target node by a message transfer function according to a preset edge message weight matrix and a preset node message weight matrix, and concatenate to generate a message vector of each source node.

The second aggregation module is configured to: aggregate the message vector of each source node according to the attention score of each node, to obtain embedding representations that include space context information and that are of each source node and each target node, and transfer the embedding representations that include space context information to the target node; and merge an embedding representation that includes time context information and that is of a source node on each edge and an embedding representation that includes space context information and that is of a target node, to obtain, according to a type of an edge, an embedding representation that includes time and space context information and that is of each type of edge.

Further, the attention module includes a plurality of connected heterogeneous graph convolution layers and linear transformation layers connected after the plurality of heterogeneous graph convolution layers; and
the attention module calculates an attention score of each node, and is specifically configured to:
concatenate embedding representations of a target node and an edge at a previous heterogeneous graph convolution layer to generate a vector dstₑ, where dstₑ is denoted as:

$${dst}_{e} = {H}^{( l - 1 )} [ dst ] \vert \vert {H}^{( l - 1 )} [ e ] ;$$

concatenate embedding representations of a source node and the edge at the previous heterogeneous graph convolution layer to generate a vector srcₑ, where srcₑ is denoted as:

srcₑ=H^{(l-1)}[src]∥H^{(l-1)}[e], where
l is a layer number of a current heterogeneous graph convolution layer; H^{(l-1)}[e] represents an embedding representation of the edge at an (l−1)^{th} heterogeneous graph convolution layer; H^{(l-1)}[src] represents an embedding representation of the source node at the (l−1)^{th} heterogeneous graph convolution layer; and H^{(l-1)}[dst] represents an embedding representation of the target node at the (l−1)^{th} heterogeneous graph convolution layer;
map the vector dstₑ and the vector srcₑ to a d^{th} Key vector K^{d}(srcₑ) and a d^{th} Query vector Q^{d}(dstₑ) by linear transformation layers K-linear-node^{d} and Q-linear-node^{d};
assign one independent node attention weight matrix Wₙ^{ATT} to different node types, and assign one independent edge attention weight matrix Wₑ^{ATT} to different edge types;
for a d^{th} attention head, calculate an attention score A_{head}^{d}(src, e, dst) of the d^{th} attention head of the source node based on the d^{th} Key vector K^{d}(srcₑ), the d^{th} Query vector Q^{d}(dstₑ), the node attention weight matrix Wₙ^{ATT}, and the edge attention weight matrix Wₑ^{ATT}, where A_{head}^{d}(src, e, dst), K^{d}(srcₑ), and Q^{d}(dstₑ) are denoted as:

$${A}_{head}^{d} ( src , e , dst ) = \frac{( {K}^{d} ( {src}_{e} ) ( {W}_{e}^{A T T} + {W}_{n}^{A T T} ) {Q}^{d} ( {dst}_{e} ) )}{\sqrt{d}} ;$$

$${K}^{d} ( s r {c}_{e} ) = K - linear - {node}^{d} ( {H}^{( l - 1 )} [ src ] \vert \vert {H}^{( l - 1 )} [ e ] ) ; and$$

$${Q}^{d} ( d s {t}_{e} ) = Q - linear - {node}^{d} ( {H}^{( l - 1 )} [ dst ] \vert \vert {H}^{( l - 1 )} [ e ] ) ; and$$

concatenate and perform normalization on attention scores of all m attention heads to obtain a final attention score Aₜₜₑₙₜᵢₒₙ(src, e, dst) between the source node and the target node at the current heterogeneous graph convolution layer, where Aₜₜₑₙₜᵢₒₙ(src, e, dst) is denoted as:

$$Attention ( src , e , d s t ) = \begin{matrix}Softmax \\ ∀ src ∈ N ( dst )\end{matrix} ( {‖}_{d ∈ [ 1 , m ]} {A}_{head}^{d} ( src , e , dst ) ) ,$$

where
N(dst) is all neighboring nodes of a target node.

Further, the second message module is configured to perform the following steps:
when the attention score at the current heterogeneous graph convolution layer is calculated, for the d^{th} attention head, performing, by a linear transformation layer V-linear-node^{d}, linear mapping on the vector srcₑ generated through concatenating the embedding representations of the source node and the edge at the previous heterogeneous graph convolution layer, where srcₑ is denoted as srcₑ=H^{(l-1)}[src]∥H^{(l-1)}[e];
assigning one independent node message weight matrix Wₙ^{MSG} to different node types, and assigning one independent edge message weight matrix Wₑ^{MSG} to different edge types;
for the d^{th} attention head, generating a message vector M_{head}^{d} of the d^{th} attention head according to the vector srcₑ obtained through linear transformation by V-linear-node^{d}, the node message weight matrix Wₙ^{MSG}, and the corresponding edge message weight matrix Wₑ^{MSG}, where M_{head}^{d} is denoted as:

M_{head}^{d}=V-linear-node^{d}(H⁽¹⁻¹⁾[src]∥H^{(l-1)}[e])(Wₑ^{MSG}+Wₑ^{MSG}); and
concatenating message vectors of all the m attention heads to obtain a final message value of the source node at the current l^{th} heterogeneous graph convolution layer, where the message value is denoted as:

$$Message ( src , e , dst ) = {‖}_{d ∈ [ 1 , m ]} {M}_{h e a d}^{d} .$$

Further, for the target node, a final message value of each source node is aggregated and transferred to the target node according to a final attention score of each target node and each source node, to obtain an embedding representation of space context information of each target node at a current heterogeneous graph convolution layer, where an embedding representation H^{l}[dst] of the target node at the l^{th} heterogeneous graph convolution layer is denoted as:

$${H}^{l} [ d s t ] = {\sum }_{∀ src ∈ N ( dst )} ( Attention ( src , e , dst ) \cdot Message ( src , e , d st ) ) .$$

Beneficial technical effects of the present disclosure are as follows:

In the present disclosure, independent heterogeneous memories and attention mechanisms of “nodes” and “edges” are integrated into information propagation processes of nodes and edges in the graph, and deep correlation in time dimension and space dimension is performed on interaction information between computer network entities carried in a continuous-time dynamic graph, so as to capture an abnormal edge (an abnormal interaction event). Complete context information of an interaction event between entities is fully utilized, so that a malicious attack is easily identified, so as to intercept an APT attack according to an abnormal edge.

### BRIEF DESCRIPTION OF THE DRAWINGS

FIG. 1 is a functional block diagram of a detection method according to an embodiment of the present disclosure.

FIG. 2 is a schematic diagram of a continuous-time dynamic heterogeneous graph according to an embodiment of the present disclosure.

FIG. 3 is a schematic structural diagram of a CDHGN according to an embodiment of the present disclosure.

### DETAILED DESCRIPTION

In the following description, specific details such as a particular system structure and technology are set forth in an illustrative but not a restrictive sense to make a thorough understanding of the embodiments of the present disclosure. However, a person skilled in the art should know that the present disclosure can also be implemented in other embodiments without these specific details. In other cases, detailed descriptions of well-known systems, apparatuses, circuits, and methods are omitted, so that the present disclosure is described without being obscured by unnecessary details.

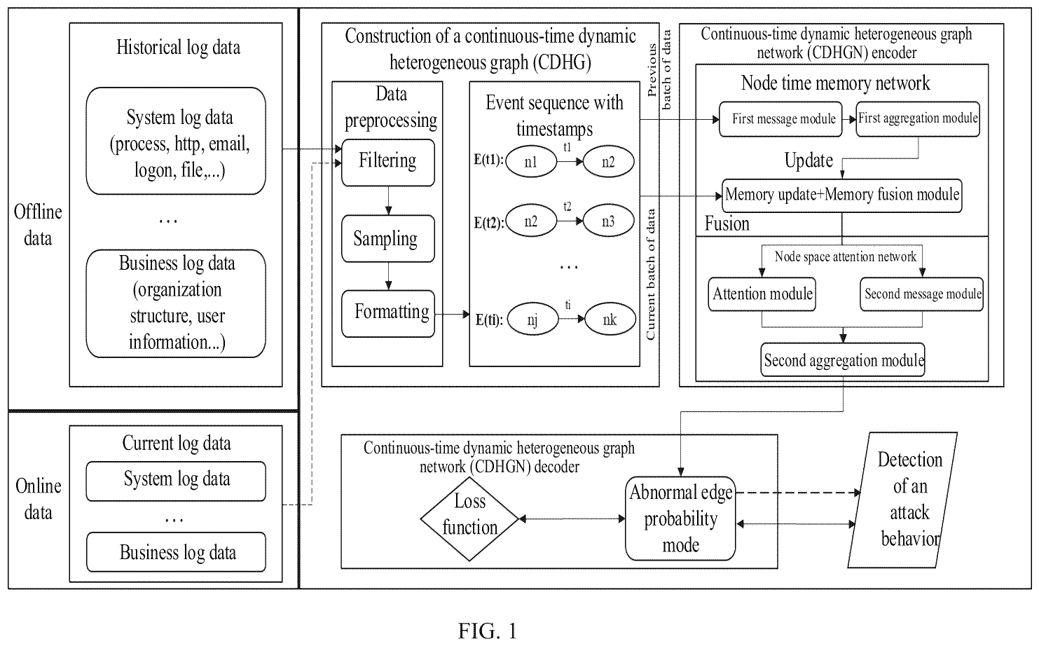

The following describes in detail an APT detection method based on a CDHGN with reference to the accompanying drawings. As shown in FIG. 1, the method includes two phases of offline data training (offline training) and online data detection (online detection).

### 1. Overall Process

Phase (1). The offline training includes the following steps:

Step 101: Obtaining of historical log data: Required data items are determined according to application scenarios, and then a large quantity of heterogeneous historical logs generated by corresponding security devices in a network are collected, for example, including but not limited to system log data (process call, http network access, email, logon to the host by the user, file access, and the like).

Step 102: Continuous-time dynamic heterogeneous graph (CDHG) construction: The historical log data provided in step 101 is preprocessed. In this embodiment, data of related users within a specified time period is selected and formatted; and behaviors between users and entities (“user-user”, “user-entity”, and “entity-entity”) are then extracted to construct a CDHG.

Step 103: Continuous-time dynamic heterogeneous graph network (CDHGN) encoder: The continuous-time dynamic heterogeneous graph data generated in step 102 is input into the CDHGN encoder for encoding, to obtain an embedding representation (vector) of a corresponding “edge” of each network interaction event.

Step 104: Continuous-time dynamic heterogeneous graph network (CDHGN) decoder: The edge embedding representation (vector) generated in step 103 is input into the CDHGN decoder to perform offline training on an abnormal edge probability model.

Phase (2). The online detection includes the following steps:

Step 201: Current log data: Log data is collected in real time based on the data items collected in the training phase.

Step 202: CDHG construction: Same as step 102 in the phase (1), namely, the offline training phase, a CDHG is constructed based on step 102 in the phase (1).

Step 203: CDHGN encoder: All parameters of the CDHGN that has been trained in the phase (1) are directly used, and an embedding representation (vector) is calculated for a corresponding “edge” of each input network interaction event.

Step 204: CDHGN decoder: The edge embedding representation (vector) generated in step 203 in the online detection stage is input into the CDHGN decoder that has been trained in the phase (1), and a detection result of whether the edge is an abnormal edge is directly output.

The “encoder-decoder” architecture is used in this method, and is explained in detail in the following “3. CDHGN encoder” and “4. CDHGN decoder”. The CDHGN encoder and the CDHGN decoder constitute a CDHGN model.

The encoder includes a node time memory network and a node space attention network.

The node time memory network includes a heterogeneous message (a first message), message aggregation (first aggregation), and memory fusion/memory update. In time dimension, the node time memory network independently aggregates and updates historical state information of different types of nodes (entities) and edges (interactions).

The node space attention network includes a heterogeneous attention (calculate an attention score of each node), transfer of a heterogeneous message (a second message), and heterogeneous message aggregation (second aggregation). In space dimension, the node space attention network performs message transfer and aggregation on neighboring nodes of nodes by a dedicated parameter matrix for different types of nodes and edges, so as to calculate heterogeneous attention scores for different types of nodes and edges.

The decoder includes a multilayer perceptron (MLP) network and a loss function. The decoder completes supervised training of the model by restoring an embedding representation of coded annotation sample data, so as to classify, as normal or abnormal according to embedding representations of a source node and a target node at a specified moment, a connecting “edge” between the two nodes, namely, an interaction event.

### 2. CDHG Construction

Optionally, the following processes are performed to preprocess original log data:
1) A filter obtains data within a specified time window from an original historical log, and filters out invalid data.
2) A sampler randomly samples an entity set and an interaction event set related to these entities within the time window.
3) A formatter performs formatting processing on the collected entities and corresponding interaction events to obtain an interaction event list arranged in an orderly manner in time.

A CDHG is used to model an interactive relationship in a computer network, where src represents a source node, and dst represents a target node; e represents an edge connecting a source node to a target node, that is, an interaction event; t represents a moment at which an interaction event occurs between a source node and a target node; src_type, dst_type, and edge_type are respectively a type of a source node, a type of a target node, and a type of an edge; and src_feats, dst_feats, and edge_feats are respectively an attribute of a source node, an attribute of a target node, and an attribute of an edge. Therefore, an interaction event log with a timestamp is defined as a ten-tuple (src,c,dst,t,src_type,dst_type,edge_type,src_feats,dst_feats,edge_feats). Accordingly, a CDHG is defined as a ten-tuple set {(src,c,dst,t,src_type,dst_type,edge_type,src_feats,dst_feats,edge_feats)}.

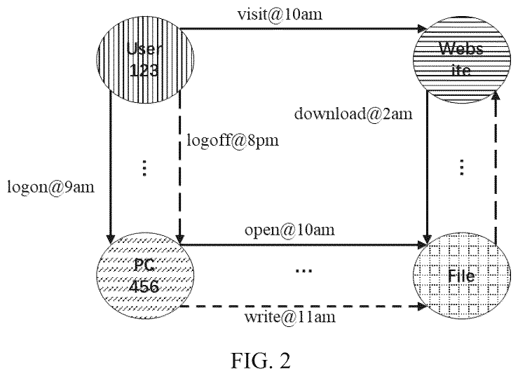

FIG. 2 shows an example of a CDHG. Different types of fill patterns and/or connecting lines represent different types of nodes and/or edges, that is, heterogeneous nodes and/or heterogeneous edges. There are many different relationships between different types of nodes in the computer network. To display continuous-time dynamic characteristics of data, a labeling mode of “Subject→Behavior@Moment→Object” is adopted. Herein, the subject is a source node src, and the object is a target node dst. For example, when a user (User123) logs into a PC (PC456) at a time t, the time t is allocated to an edge between the user and the pc. According to an event occurrence time, each node may allocate operations corresponding to a plurality of timestamps: User123→logon@9 am→PC456 represents that the User123 performs a logon operation on the PC456 at 9:00 am, which means that the employee just opens the computer at the workstation in the morning. By analogy, PC456→visit@10 am→Website and Website→download@11 am→File represent that the PC456 performs visit access to a website at 10:00 am, and then downloads a file at 11:00 am; PC456→open@2 pm→File and PC456→write@5 pm→File represent that the PC456 opens the file at 2:00 pm and performs a write operation on the file at 5:00 μm; and User123→logoff@8 pm→PC456 represents that the User123 performs a logoff operation on the PC456 at 8:00 pm, which may mean that the employee closes the computer after work.

### 3. CDHGN Encoder

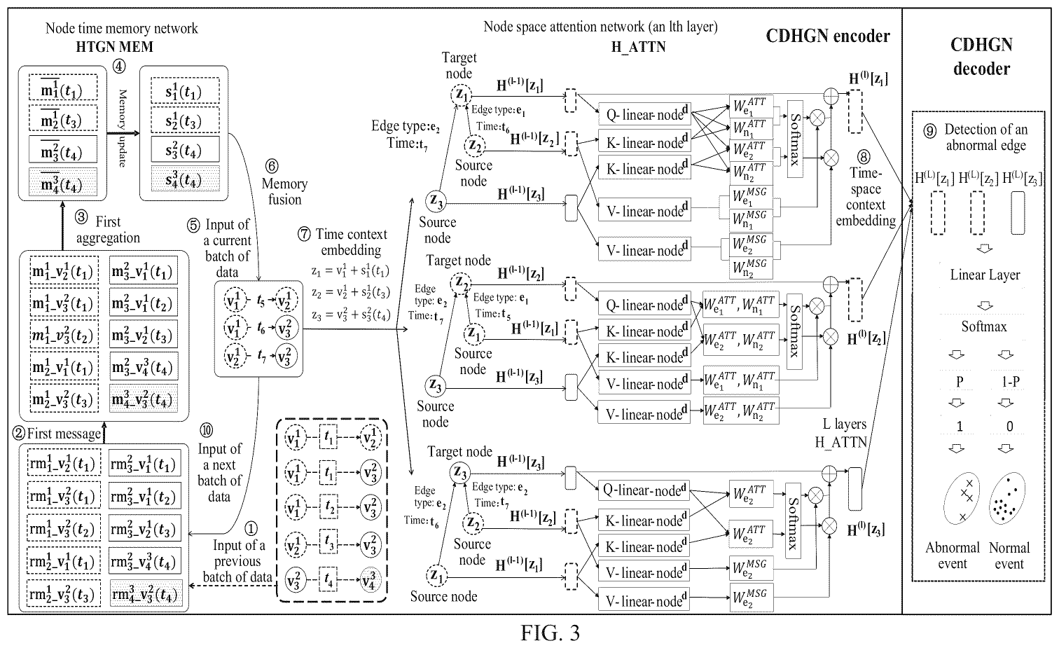

As shown in FIG. 3, the CDHGN encoder includes a node time memory network and a node space attention network. The following describes related formula variables.

In formulas, vⱼⁱ is a j^{th} node of a i^{th}-class node; v_{q}^{p} is a q^{th} node of a p^{th}-class node; e_{jq}^{ip}(t) is an edge connecting the node vⱼⁱ to the node v_{q}^{p}; sⱼⁱ (t⁻) is a memory of the node vⱼⁱ before a moment t; s_{q}^{p}(t⁻) is a memory of the node v_{q}^{p} before the moment t; msgₛ is a message function of a source node, and msg_{d} is a message function of a target node; mⱼⁱ_v_{q}^{p}(t) is a message value of the node vⱼⁱ (connected to the node v_{q}^{p}); m_{q}^{p}_vⱼⁱ(t) is a message value of the node v_{q}^{p} (connected to the node vⱼⁱ); agg is an aggregation function; sⱼⁱ(t) is a memory of the node vⱼⁱ at the moment t; zⱼ is an embedding representation of a node j that fuses historical information; A_{head}^{d}(src, e, dst) is an attention score of a d^{th} attention head of the source node; H^{(l-1)}[e] is an embedding representation of an edge at an (l−1)^{th} heterogeneous graph convolution layer; H^{(l-1})[src] is an embedding representation of the source node at the (l−1)^{th} heterogeneous graph convolution layer; K^{d}(srcₑ) is a d^{th} Key vector; Q^{d}(dstₑ) is a d^{th} Query vector; Wₑ^{ATT} is an edge attention weight matrix; N(dst) is all neighboring nodes of the target node; M_{head}^{d} is a message vector of the d^{th} attention head; Wₑ^{MSG} is an edge message weight matrix; and H^{l}[dst] is an embedding representation of the target node at an l^{th} heterogeneous graph convolution layer.

A specific calculation process may be divided into the following steps:
(1) Input of a previous batch of data: The previous batch of raw data is quantized to obtain an input vector.
(2) First message: A message value of an input node is calculated based on the input vector in step (1) by a first message function (heterogeneous message function).
(3) First aggregation: Message values of nodes in this batch are aggregated according to an aggregation policy.
(4) Memory update: A historical memory embedding of each node is generated by an LSTM cyclic neural network.
(5) Input of a current batch of data: The current batch of raw data is quantized to obtain an input vector.
(6) Memory fusion: Historical memories of nodes involved in the current batch of data are fused with the input vector obtained in step (5). The fusion herein is performed in a vector addition manner, but the fusion manner is not limited to this manner.
(7) Time context embedding: An embedding representation of each node is calculated based on step (6), namely, a vector value, that is, an embedding representation of a time context of the node.
(8) Time-space context embedding: The embedding of the time context of each node obtained in step (7) is input into the node attention network of L layers to obtain an embedding representation of a time-space context of each node; and embedding representations of time-space contexts of the source node and the target node are merged to obtain an embedding representation of a time-space context of an edge.
(9) Detection of an abnormal edge: The embedding representation of the time-space context of the edge obtained in step (8) is input into a CDHGN decoder and it is determined that the edge is normal or abnormal.
(10) Input of a next batch of data: The next batch of raw data is quantized to obtain an input vector of the next batch. The above steps are repeated.

The following gives detailed descriptions.

### (1) Node Time Memory Network

The node time memory network includes a heterogeneous message (a first message), message aggregation (first aggregation), and memory fusion/memory update. In time dimension, the node time memory network independently aggregates and updates historical information of different types of nodes (entities) and edges (interactions).

The node space attention network includes a heterogeneous attention (attention), transfer of a heterogeneous message (a second message), and heterogeneous message aggregation (second aggregation). In space dimension, the node space attention network performs message transfer and aggregation on neighboring nodes of nodes by a dedicated parameter matrix for different types of nodes and edges, so as to calculate heterogeneous attention scores for different types of nodes and edges.

### 11) Heterogeneous Message

Corresponding message values of all network interaction events involving a node vⱼⁱ (entity) are generated. If an interaction event occurs between a source node and a target node at a moment t, an edge e_{jq}^{ip}(t) connecting the node vⱼⁱ to a node vₚ^{q} is generated, and two messages mⱼⁱ_v_{q}^{p}(t) and m_{q}^{p}_vⱼⁱ(t) are generated, where the message mⱼⁱ_v_{q}^{p}(t) represents a message value of the node vⱼⁱ (connected to the node v_{q}^{p}), and m_{q}^{p}_vⱼⁱ(t) represents a message value of the node v_{q}^{p} (connected to the node vⱼⁱ).

mⱼⁱ_v_{q}^{p}(t)=msgₛ(sⱼⁱ(t⁻),s_{q}^{p}(t⁻),Δt,e_{jq}^{ip}(t)); and

m_{q}^{p}_vⱼⁱ(t)=msg_{d}(s_{q}^{p}(t⁻),sⱼⁱ(t⁻),Δt,e_{jq}^{ip}(t)), where

Δt represents a time interval. A message function msgₛ of the source node and a message function msg_{d} of the target node directly concatenate input vectors. The message function herein may be extended to a learnable function.

### 12) Message Aggregator

In a model training process, for data in one training batch, a plurality of interaction events involve a same node vⱼⁱ. Therefore, when each interaction event generates one message, the following mechanism is used to aggregate mⱼⁱ_v_{q}^{p}(t₁), . . . , mⱼⁱ_vᵥ^{u}(t_{w}) to obtain an aggregation result m̅ⱼ̅ⁱ̅(t), where t₁, . . . , t_{w}≤t, where

m̅ⱼ̅ⁱ̅(t)=agg(mⱼⁱ_v_{q}^{p}(t₁), . . . ,mⱼⁱ_vᵥ^{u}(t_{w}), where
t₁ . . . , t_{w} represent moments at which interaction events occur on the source node in this batch, and t represents a moment at which an interaction event occurs between the source node and the target node, that is, a current moment at which each interaction event occurs on the source node in this batch.

Herein, agg represents an aggregation function. In this phase, the aggregation function faces three cases based on heterogeneity:
Case 1: A same source node is connected to different target nodes at the same time.
Case 2: A same source node is connected to a same node at different times.
Case 3: A same source node is connected to different nodes at different times.

Accordingly, aggregation strategies of the aggregation function are classified into three types: In case 1, the aggregation function takes an average value of all messages. In case 2, the aggregation function retains only a message value of a given node at a latest moment. In case 3, the aggregation function is set to an average value of all messages. Herein, each aggregation policy of the aggregation function may be set to a learnable function.

### 13) Memory Update

$${s}_{j}^{i} ( t ) = mem ( \overline{{m}_{j}^{i}} ( t ) , {s}_{j}^{i} ( {t}^{-} ) )$$

Memory information of nodes (a source node and a target node) involved in each interaction event (edge) is updated after the interaction event occurs. Herein, mem is a learnable memory update function, and a long short-term memory (LSTM) network is used.

### 14) Memory Fusion

Memory information is updated for a previous batch of data. When an interaction event of a current batch arrives, the latest information of nodes involved in this batch of data is fused with historical information of these nodes by a fusion function. The fusion function herein is defined as follows:

zⱼ=\vec{vⱼⁱ}+sⱼⁱ(t), where
\vec{vⱼⁱ} represents a vector formed by an attribute of the node vⱼⁱ.

### (2) Node Space Attention Network

After the calculation process of the node time memory network, each node vⱼⁱ in each batch obtains an embedding representation zⱼ corresponding to each node. Next, an embedding representation of a node j that fuses historical information is input into the node space attention network.

In space dimension, the node space attention network performs message transfer and aggregation on neighboring nodes of nodes by a dedicated parameter matrix for different types of nodes and edges, so as to calculate heterogeneous attention scores for different types of nodes and edges.

A heterogeneous attention network includes a heterogeneous attention (attention), transfer of a heterogeneous message (a second message), and heterogeneous message aggregation (second aggregation): 1) In the heterogeneous attention, weights of source nodes connected to different edges are calculated. 2) In the transfer of the heterogeneous message, information about a source node and an edge is extracted. 3) In the heterogeneous message aggregation, information about all source nodes of a target node is obtained through aggregation by an attention weight coefficient.

### 21) Attention-Heterogeneous Attention

For an interaction event (edge) e, an embedding representation z_{dst} of a target node and an embedding representation z_{src} of a source node src are set. The target node dst is then mapped to a Query vector, and the source node src is mapped to a Key vector.

In a complex APT attack detection task, to better use information included in an edge connecting a source node to a target node, a feature of the edge is separately concatenated with the Query vector and the Key vector to obtain a vector dstₑ and a vector srcₑ. To maximize parameter sharing while still maintaining uniqueness between different relationships, independent parameter matrices are used for different types of nodes and edges, where ∥ is a concatenating function. A calculation mechanism of an attention score Attention(src, e, dst) is as follows:

$${K}^{d} ( s r {c}_{e} ) = K - linear - {node}^{d} ( {H}^{( l - 1 )} [ src ] \vert \vert {H}^{( l - 1 )} [ e ] ) ;$$

$${Q}^{d} ( d s {t}_{e} ) = Q - linear - {node}^{d} ( {H}^{( l - 1 )} [ dst ] \vert \vert {H}^{( l - 1 )} [ e ] ) ;$$

$${A}_{head}^{d} ( src , e , dst ) = \frac{( {K}^{d} ( {src}_{e} ) ( {W}_{e}^{A T T} + {W}_{n}^{A T T} ) {Q}^{d} ( {dst}_{e} ) )}{\sqrt{d}} ; and$$

$$Attention ( src , e , d s t ) = \begin{matrix}Softmax \\ ∀ src ∈ N ( dst )\end{matrix} ( {‖}_{d ∈ [ 1 , m ]} {A}_{head}^{d} ( src , e , dst ) ) .$$

First, embedding representations of the target node and the edge at a previous heterogeneous graph convolution layer are concatenated to generate the vector dstₑ, where dstₑ is denoted as dstₑ=H^{(l-1)}[dst]∥H^{(l-1)}[e]; embedding representations of the source node and the edge at the previous heterogeneous graph convolution layer are concatenated to generate the vector srcₑ, where srcₑ is denoted as srcₑ=H^{(l-1)}[src]∥H^{(l-1)}[e], where l is a layer number of a current heterogeneous graph convolution layer;
the vector dstₑ and the vector srcₑ are mapped to a d^{th} Key vector K^{d}(srcₑ) and a d^{th} Query vector Q^{d}(dstₑ) by linear transformation layers K-linear-node^{d} and Q-linear-node^{d};
one independent node attention weight matrix Wₙ^{ATT} is assigned to different node types, and one independent edge attention weight matrix Wₑ^{ATT} is assigned to different edge types;
for a d^{th} attention head, an attention score A_{head}^{d}(src, e, dst) of the d^{th} attention head of the source node is calculated based on the vector K^{d}(srcₑ), the vector Q^{d}(dstₑ), the node attention weight matrix Wₙ^{ATT}, and the edge attention weight matrix Wₑ^{ATT}, where A_{head}^{d}(src, e, dst) is denoted as:

$${A}_{head}^{d} ( src , e , dst ) = \frac{( {K}^{d} ( {src}_{e} ) ( {W}_{e}^{A T T} + {W}_{n}^{A T T} ) {Q}^{d} ( {dst}_{e} ) )}{\sqrt{d}} ,$$

where

K^{d}(srcₑ) and Q^{d}(dstₑ), are intermediate parameters and denoted as:

K^{d}(srcₑ)=K-linear-node^{d}(H^{(l-1)}[src]∥H^{(l-1)}[e]), and

Q^{d}(dstₑ)=Q-linear-node^{d}(H^{(l-1)}[dst]∥H^{(l-1)}[e]); and
attention scores of all m attention heads are concatenated and normalization is performed by a Softmax function to obtain a final attention score Aₜₜₑₙₜᵢₒₙ(src, e, dst) of the source node at the current heterogeneous graph convolution layer, where Aₜₜₑₙₜᵢₒₙ(src, e, dst) is denoted as:

$$Attention ( src , e , dst ) = \begin{matrix}Softmax \\ ∀ src ∈ N ( dst )\end{matrix} ( {‖}_{d ∈ [ 1 , m ]} {A}_{head}^{d} ( src , e , dst ) ) .$$

### 22) Transfer of a Heterogeneous Message

When the attention score at the current heterogeneous graph convolution layer is calculated, for the d^{th} attention head, linear mapping is performed on the vector srcₑ generated through concatenating the embedding representations of the source node and the edge at the previous heterogeneous graph convolution layer by a linear transformation layer V-linear-node^{d}, where srcₑ is denoted as srcₑ=H^{(l-1)}[src]∥H^{(l-1)}[e];
then, one independent node message weight matrix Wₙ^{MSG} is assigned to different node types, and one independent edge message weight matrix Wₑ^{MSG} is assigned to different edge types, to mitigate a distribution difference between different types of nodes and edges;
then, for the d^{th} attention head, a message vector M_{head}^{d} of the d^{th} attention head is generated according to the vector srcₑ obtained through linear transformation by V-linear-node^{d}, Wₙ^{MSG}, and Wₑ^{MSG}, head is denoted as:

M_{head}^{d}=V-linear-node^{d}(H^{(l-1)}[src]∥H^{(l-1)}[e])(Wₑ^{MSG}+Wₙ^{MSG}); and
then, message vectors of all the m attention heads are concatenated to obtain a final message value of the source node at the current heterogeneous graph convolution layer, where the message value is denoted as

$$Message ( src , e , dst ) = {‖}_{d ∈ [ 1 , m ]} {M}_{h e a d}^{d} .$$

### 23) Aggregation of Heterogeneous Messages

Finally, in an aggregation phase, information about the source node and the target node is aggregated according to different edge connecting relationships.

For the target node, a message value of each source node is aggregated according to attention values of each target node and each source node, and then transferred to the target node, to obtain an embedding representation of each target node at the l^{th} heterogeneous graph convolution layer, which is denoted as:

H^{l}[dst]=Σ_{∀src∈N(dst)}(Attention(src,e,dst)·Message(src,e,dst)), where
concepts of the source node and the target node are relative, where a node A points to a node B, the node A is a source node, and when a node C points to the node A, the node A is a target node.

Finally, the encoder merges the embedding representations of the source node and the target node on the edge to obtain an embedding representation that includes time and space context information and that is of each type of edge for use by the decoder. It should be noted that in this application, a specific merging manner does not need to be limited, and there may be many “merging” methods. For example, in an embodiment, adding, vector dot multiplication, or averaging is used.

### 4. CDHGN Decoder

The CDHGN decoder is an MLP network structure. The decoder completes supervised training of the model by restoring an embedding representation of coded annotation sample data, so as to calculate, according to embedding representations of a source node and a target node at a specified time point, a connection between the two nodes, that is, whether an interaction event is abnormal. Finally, the decoder outputs (that is, the model outputs) a detection result of whether each type of edge is an abnormal edge, so as to intercept an APT attack according to the abnormal edge (that is, an abnormal interaction event).

### Abnormal Edge Probability Model

Most of graph neural networks focus on obtaining embedding representations of nodes, but a complex APT attack detection task depends on a relationship between edges in the graph to determine whether there is an attack behavior. Therefore, in this method, embedding representations of nodes on both sides of an edge are concatenated to obtain an embedding representation of the edge, and then the embedding representation of the edge is input into a fully-connected layer to be mapped to a high-dimensional feature space, and finally is input into a SoftMax layer to obtain a probability that the edge belongs to an attack interaction event.

### Loss Function

Herein, detection of an attack behavior has only a positive case and a negative case, and is a binary task. A sum of probabilities of the two cases is 1. A binary cross-entropy loss function is defined as follows:

L(\tilde{y}ᵢ(t),yᵢ(t))=−(yᵢ(t)· log(\tilde{y}ᵢ(t))+(1−yᵢ(t))· log(1− [symbol] (t))), where
\tilde{y}ᵢ(t) is a result of determining that an i^{th} edge at a moment t output by the CDHGN model is abnormal, and yᵢ(t) is a corresponding sample label value.

### 5. Test Analysis

### 51) Baseline Method

Baseline methods in the tests include Tiresias (Tiresias: Predicting security events through deep learning [J]. Proceedings of the 2018 ACM SIGSAC Conference on Computer and Communications Security, 2018), Log 2vec/Log 2vec++ (Log 2vec: A heterogeneous graph embedding based approach for detecting cyber threats within enterprise [J]. Proceedings of the 2019 ACM SIGSAC Conference on Computer and Communications Security, 2019), Ensemble (An unsupervised multidetector approach for identifying malicious lateral movement [C]//2017 IEEE 36th Symposium on Reliable Distributed Systems (SRDS). IEEE, 2017:224-233), Markov-c (A new take on detecting insider threats: exploring the use of hidden markov models [C]//Proceedings of the 8th ACM CCS International workshop on managing insider security threats. 2016:47-56), StreamSpot (Fast memory-efficient anomaly detection in streaming heterogeneous graphs [C]//Proceedings of the 22nd ACM SIGKDD International Conference on Knowledge Discovery and Data Mining. 2016:1035-1044), and RShield (A refined shield for complex multi-step attack detection based on temporal graph network [C]//DASFAA. 2022).

Tiresias is an advanced log-level supervising method. Anomaly detection is predicted for a future interaction event through a recurrent neural network (RNN) according to historical interaction event data. This method can predict a secure interaction event in various interaction events with noise.

Log 2vec is an unsupervised method that classifies a malicious activity and a benign activity into different clusters and identifies a malicious activity. The method includes graph construction, graph embedding learning, and a detection algorithm. Specifically, in Log 2vec, a heterogeneous graph that includes a relationship mapping between logs is first constructed by a rule-based heuristics method, and typical behaviors and malicious operations of users may be represented through mapping; second, in Log 2vec, a log is converted into a sequence and a subgraph based on a manually set rule, so as to construct a heterogeneous graph; and finally, for different attack scenarios, in Log 2vec, a context of each node is extracted by improving a random walk manner, and a category of a malicious behavior is identified by a clustering method.

Ensemble proposes an attack detection method based on lateral movement. In this method, a security state of a target system is modeled by a graph model, and abnormal behaviors with a plurality of behavior indicators of an infected host are associated and identified by a plurality of anomaly detection techniques.

The Markov-c study detects existence of an internal abnormal behavior by modeling normal behaviors of users. Specifically, a hidden Markov model is used to learn constituent elements of a normal behavior, and then the elements are used to detect a significant deviation from the behavior.

StreamSpot is an advanced method for detecting a malicious information stream. Firstly, a graph summary is obtained, and then an anomaly in the summary is determined through clustering.

RShield is a supervised multi-step complex attack detection model based on a TGN model. This model introduces a continuous graph construction method to model a network behavior. Based on this, an improved time graph classifier is used to detect a malicious network interaction event. This model only supports homogeneous graph modeling, and the ability to capture context information of a network entity behavior is still limited.

### 52) Evaluation Index

To measure a detection result mentioned in the study, an area under curve (AUC) score is used as a performance index in this method. The AUC is relatively insensitive to imbalance of a dataset, and reaches its best value at a value 1 and reaches its worst value at a value 0. If a method has a higher AUC score in the dataset, its prediction is considered to be correct.

### 53) Test Environment

The tests are run on the PC host of Intel Core i9 2.8 GHz 32 GB RAM. The operating system is Windows 10 64 bit, and GPU is Nvidia RTX2060s with 8 GB. The prototype system is developed based on python, the version is 3.8.5, and the pytorch version is 1.10.0. This implements CDHGN construction, CDHGN model training, and detection of a streaming abnormal interaction event.

### 54) Dataset

Two cyber security datasets are used in the tests: One is a real dataset—an LANL integrated cyber security interaction event dataset (Cyber security data sources for dynamic network research [M]//Dynamic Networks and Cyber-Security. [S.1.]: World Scientific, 2016:37-65), and the other is a dataset generated by artificial intelligence—a CERT insider threat test dataset (Bridging the gap: A pragmatic approach to generating insider threat data [C]//2013 IEEE Security and Privacy Workshops. IEEE, 2013:98-104).

The LANL dataset represents 58 consecutive days of interaction event data collected from five sources in the company's internal computer network (authentication, process, network flow, DNS and redteam). An authentication interaction event in the LANL dataset includes 1,648,275,307 logs collected within 58 days for 12,425 users and 17,684 computers in the LANL company's internal computer network. The redteam data is attacked interaction events manually labeled by members of the Red Team in authentication data, and these interaction events are used as a basic fact of bad behaviors different from normal users and computer activities. Therefore, in this specification, only authentication data is used to form a continuous-time dynamic graph to detect a malicious sample. In a preprocessing phase, a subset of the LANL dataset is randomly selected in this specification, including 9,918,928 edges generated from 10,895 nodes (user-host pairs) and all 691 malicious interaction events generated from 104 users.

The CERT dataset includes interaction event logs of internal threat activities from a simulator computer network. The dataset is generated by a complex user model and includes five log files that simulate computer-based activities of all employees in the organization, including logon/logoff activities, http traffic, email traffic, file operations, and external storage device usage. These activities are used in combination with an organization structure and user information. During 516 days, 4,000 users generated 135,117,169 interaction events (logs), including attack interaction events manually input by an expert in the field, which represent five types of ongoing internal threat scenarios. In addition, user attribute metadata is further included, namely, six attributes: a role, a project, a functional unit, a department, a team, and a supervisor. Unlike the LANL dataset, the CERT (V6.2) dataset is a sequence of attack steps of only one malicious user in a same scenario in five attack scenarios, which makes supervised detection tasks more challenging. In raw data, logs of internal personnel activities are stored in five separate files (logon/close, removable devices, http, e-mail, and file operations). Therefore, heterogeneous log information is integrated into a homogeneous file, and feature extraction is performed on a malicious behavior of an internal personnel. In this specification, two types of information are extracted from the CERT dataset as data features: an attribute feature and a statistical feature. The attribute feature includes metadata of the foregoing six user attributes, an email address, a behavior, and a timestamp. The statistical feature includes whether to log in to or use a mobile device outside normal working hours, whether to leave the office within 2 months, whether to access a suspicious web page such as “wikileaks.org”, and whether to log in to another person's account.

### 55) Test Result

In this specification, CDHGN is compared with state-of-the-art baseline methods Tiresias, Log 2vec/Log 2vec++, Ensemble, Markov-c, StreamSpot, and RShield for the LANL and CERT datasets.
1) Detection results (AUC values) in different methods on a typical dataset are shown in Table 1.

TABLE 1
Detection results in different methods
on a typical dataset (AUC value)

| Methods | LANL Dataset | CERT Dataset |
|---|---|---|
| Tiresias | 0.8500 | 0.3900 |
| Ensemble method | 0.8900 | / |
| Markov-c | / | 0.8000 |
| StreamSpot | / | 0.7000 |
| Log2vec | 0.9100 | 0.8600 |
| Log2vec++ | / | 0.9300 |
| RShield (Transductive) | 0.9631 | 0.9438 |
| RShield (Inductive) | 0.9714 | 0.9553 |
| CDHGN (Transductive) | 0.9977 | 0.9992 |
| CDHGN (Inductive) | 0.9991 | 0.9997 |

2) CDHGN ablation test results (transductive setting, AUC values), see Table 2.
H-ATTN: Heterogeneous attention network
TGN_MEM+TGAT: Homogeneous memory network+homogeneous attention network
HTGN_MEM+TGAT: Heterogeneous memory network+homogeneous attention network
HTGN_MEM+H_ATTN: Heterogeneous memory network+heterogeneous attention network

TABLE 2
CDHGN ablation test results

| | | | | | CDHGN internal modules | | | |
|---|---|---|---|---|---|---|---|---|
| | Dataset | # Number of abnormal samples | | | | TGN_MEM + | HTGN_MEM + | HTGN_MEM + |
| Dataset | partitioning | #Train | #Val | #Test | H-ATTN | TGAT | TGAT | H-ATTN |
| LANL | 0.8:0.1:0.1 | 553 | 69 | 69 | 0.8353 | / | 0.9994 | 0.9998 |
| | 0.5:0.3:0.2 | 346 | 207 | 138 | 0.8353 | 0.9726 | 0.9974 | 0.9974 |
| | 0.27:0.03:0.7 | 187 | 21 | 483 | 0.9366 | 0.9810 | 0.9972 | 0.9977 |
| CERT | 0.8:0.1:0.1 | 378 | 50 | 42 | 0.8816 | 0.9438 | 0.9950 | 0.9992 |
| | 0.5:0.3:0.2 | 235 | 143 | 92 | 0.8816 | 0.8345 | 0.9922 | 0.9358 |
| | 0.27:0.03:0.7 | 127 | 14 | 329 | 0.8816 | / | 0.6686 | 0.9597 |

3) CDHGN ablation test results (inductive setting, AUC values), see Table 3.

TABLE 3
CDHGN ablation test results

| | | | | | CDHGN internal modules | | | |
|---|---|---|---|---|---|---|---|---|
| | Dataset | # Number of abnormal samples | | | | TGN_MEM + | HTGN_MEM + | TGN_MEM + |
| Dataset | partitioning | #Train | #Val | #Test | H-ATTN | TGAT | TGAT | H-ATTN |
| LANL | 0.8:0.1:0.1 | 486 | 69 | 136 | 0.7764 | / | 0.9969 | 0.9991 |
| | 0.5:0.3:0.2 | 303 | 207 | 181 | 0.7764 | 0.9722 | 0.9871 | 0.9857 |
| | 0.27:0.03:0.7 | 144 | 21 | 526 | 0.8457 | 0.9714 | 0.9226 | 0.9866 |
| CERT | 0.8:0.1:0.1 | 376 | 47 | 47 | 0.7934 | 0.9995 | 0.7032 | 0.9997 |
| | 0.5:0.3:0.2 | 101 | 141 | 228 | 0.7934 | 0.9021 | 0.6409 | 0.9711 |
| | 0.27:0.03:0.7 | 94 | 14 | 362 | 0.7934 | / | 0.6034 | 0.9021 |

Table 2 shows that the CDHGN performs better than other baseline methods for the international common datasets LANL and CERT. In the LANL dataset, compared with the SOTA method RShield, the CDHGN increases AUC values by 3.4% and 5.6% respectively through transductive and inductive settings. In the CERT dataset, the AUC values are increased by 2.8% and 4.4% respectively through transductive and inductive settings compared with the SOTA method RShield. It should be noted that RShield does not support a heterogeneous graph, and therefore there will be a bigger gap in effects in the actual network.

Table 2 and Table 3 show different detection effects of the CDHGN in different module combinations. When a heterogeneous memory network (HTGN_MEM) and a heterogeneous attention network (H-ATTN) are used simultaneously, the CDHGN has achieved best results for the LANL and CERT datasets, which are 0.9991 and 0.9997 respectively.

It can be learned from the test results that the CDHGN method has a better detection effect for both the two datasets. On the one hand, when more data is used for training, that is, a training set, a verification set, and a test set are divided according to 0.8:0.1:0.1, AUC values may reach 0.9998, 0.9992 (transductive), 0.9991, and 0.9997 (inductive) respectively. On the other hand, when less data is used for training, that is, when a training set, a verification set, and a test set are divided according to 0.22:0.04:0.74, AUC values may still reach 0.9977, 0.9597 (transductive), 0.9866, and 0.9021 (inductive). The LANL and CERT datasets in the tests are already widely used mature datasets, and are also used in other tests by the baseline methods. Therefore, tests performed on this dataset may demonstrate the generalization and validity of the method.

Corresponding to the APT detection method provided in the foregoing embodiment, the present disclosure further provides an APT detection system based on a CDHGN, including a graph constructing module, a network encoder, and a network decoder.

The graph constructing module is configured to: select network interaction event data in a specified time period, extract entities from the network interaction event data as source nodes and target nodes, extract an interaction event occurring between a source node and a target node as an edge, and determine a type and an attribute of a node, a type and an attribute of the edge, and a moment at which an interaction event occurs, to obtain a continuous-time dynamic heterogeneous graph.

The network encoder is configured to convert each type of edge in the continuous-time dynamic heterogeneous graph into a vector, to obtain an embedding representation of each type of edge.

The network decoder is configured to decode the embedding representation of each type of edge in the continuous-time dynamic heterogeneous graph to obtain a detection result of whether each type of edge is an abnormal edge, so as to intercept an APT attack according to the abnormal edge.

Further, the system further includes a training module, and the training module is configured to train the network encoder and the network decoder.

Further, the CDHGN encoder includes a node time memory network and a node space attention network; the node time memory network includes a first message module, a first aggregation module, a memory update module, and a memory fusion module; and the node space attention network includes an attention module, a second message module, and a second aggregation module.

The first message module is configured to: for each edge in the continuous-time dynamic heterogeneous graph, separately generate, by a message function according to a time interval between a current moment and a previous moment at which an interaction event occurs, an edge connecting a source node to a target node, and embedding representation memories of the source node and the target node at the previous moment at which an interaction event occurs, message values corresponding to each source node and each target node at the current moment at which an interaction event occurs.

The first aggregation module is configured to separately perform, by an aggregation function, message aggregation on message values corresponding to all source nodes and target nodes in this batch at a current moment at which each interaction event occurs, to separately obtain aggregated message values of each source node and each target node at the current moment at which an interaction event occurs.

The memory update module is configured to: after an interaction event occurs between a source node and a target node, update, according to the aggregated message values of each source node and each target node at the current moment at which an interaction event occurs and the embedding representation memories of each source node and each target node at the previous moment at which an interaction event occurs, embedding representation memories of each source node and each target node in this batch at the current moment at which an interaction event occurs.

The memory fusion module is configured to: perform memory fusion on the updated embedding representation memories of each source node and each target node in this batch at the current moment with vector representations with node attributes of each source node and each target node in this batch, to obtain embedding representations that include time context information and that are of each source node and each target node in this batch.

The attention module is configured to calculate an attention score of each node according to the embedding representations that include time context information and that are of each source node and each target node, an edge between each source node and each target node, a preset node attention weight matrix, and a preset edge attention weight matrix.

The second message module is configured to: extract a multi-head message value of each source node corresponding to a target node by a message transfer function according to a preset edge message weight matrix and a preset node message weight matrix, and concatenate to generate a message vector of each source node.

The second aggregation module is configured to: aggregate the message vector of each source node according to the attention score of each node, to obtain embedding representations that include space context information and that are of each source node and each target node, and transfer the embedding representations that include space context information to the target node; and merge an embedding representation that includes time context information and that is of a source node on each edge and an embedding representation that includes space context information and that is of a target node, to obtain, according to a type of an edge, an embedding representation that includes time and space context information and that is of each type of edge.

In another embodiment, the foregoing APT detection system based on a CDHGN includes a processor, and the processor is configured to execute the foregoing program modules stored in a memory, including a graph constructing module, a network encoder, a network decoder, a training module, a first message module, a first aggregation module, a memory update module, a memory fusion module, an attention module, a second message module, and a second aggregation module.

A person skilled in the art may clearly understand that for ease and brevity of description, for detailed working processes of the modules in the system described above, refer to the corresponding processes in the foregoing method embodiment. Details are not described herein again.

A person skilled in the art should understand that the embodiments of this application may be provided as a method, a system, or a computer program product. Therefore, this application may use a form of hardware only embodiments, software only embodiments, or embodiments with a combination of software and hardware. In addition, this application may use a form of a computer program product that is implemented on one or more computer-usable storage media (including but not limited to a disk memory, a CD-ROM, and an optical memory) that include computer usable program code.

1. An advanced persistent threat (APT) detection method based on a continuous-time dynamic heterogeneous graph network (CDHGN), comprising:
selecting network interaction event data in a specified time period, extracting entities from the network interaction event data as source nodes and target nodes, extracting an interaction event occurring between a source node and a target node as an edge, and determining a type and an attribute of a node, a type and an attribute of the edge, and a moment at which an interaction event occurs, to obtain a continuous-time dynamic heterogeneous graph;
converting each type of edge in the continuous-time dynamic heterogeneous graph into a vector by a CDHGN encoder, to obtain an embedding representation of each type of edge; and
decoding the embedding representation of each type of edge in the continuous-time dynamic heterogeneous graph by a CDHGN decoder to obtain a detection result of whether each type of edge is an abnormal edge, so as to intercept an APT attack according to the abnormal edge.

2. The APT detection method based on a CDHGN according to claim 1, wherein the continuous-time dynamic heterogeneous graph is represented as a ten-tuple set and denoted as:
{(src,c,dst,t,src_type,dst_type,edge_type,src_feats,dst_feats,edge_feats)}, wherein
src represents a source node, and e represents an edge connecting a source node to a target node; dst represents a target node; t represents a moment at which an interaction event occurs between a source node and a target node; src_type, dst_type, and edge_type are respectively a type of a source node, a type of a target node, and a type of an edge; and src_feats, dst_feats, and edge_feats are respectively an attribute of a source node, an attribute of a target node, and an attribute of an edge.

3. The APT detection method based on a CDHGN according to claim 1, wherein the converting each type of edge in the continuous-time dynamic heterogeneous graph into a vector by a CDHGN encoder, to obtain an embedding representation of each type of edge comprises:
for each edge in the continuous-time dynamic heterogeneous graph, separately generating, by a message function according to a time interval between a current moment and a previous moment at which an interaction event occurs, an edge connecting a source node to a target node, and embedding representation memories of the source node and the target node at the previous moment at which an interaction event occurs, message values corresponding to each source node and each target node at the current moment at which an interaction event occurs;
separately performing, by an aggregation function, message aggregation on message values corresponding to all source nodes and target nodes in a batch at a current moment at which each interaction event occurs, to separately obtain aggregated message values of each source node and each target node at the current moment at which an interaction event occurs;
after an interaction event occurs between a source node and a target node, updating, according to the aggregated message values of each source node and each target node at the current moment at which an interaction event occurs and the embedding representation memories of each source node and each target node at the previous moment at which an interaction event occurs, embedding representation memories of each source node and each target node in the batch at the current moment at which an interaction event occurs;
performing memory fusion on the updated embedding representation memories of each source node and each target node in the batch at the current moment with vector representations with node attributes of each source node and each target node in the batch, to obtain embedding representations that comprise time context information and that are of each source node and each target node in the batch;
calculating an attention score of each node according to the embedding representations that comprise time context information and that are of each source node and each target node, an edge between each source node and each target node, a preset node attention weight matrix, and a preset edge attention weight matrix;
extracting a multi-head message value of each source node corresponding to a target node by a message transfer function according to a preset edge message weight matrix and a preset node message weight matrix, and concatenating to generate a message vector of each source node;
aggregating the message vector of each source node according to the attention score of each node, to obtain embedding representations that comprise space context information and that are of each source node and each target node, and transferring the embedding representations that comprise space context information to the target node; and
merging an embedding representation that comprises time context information and that is of a source node on each edge and an embedding representation that comprises space context information and that is of a target node, to obtain, according to a type of an edge, an embedding representation that comprises time and space context information and that is of each type of edge.

4. The APT detection method based on a CDHGN according to claim 3, wherein when message aggregation is performed:
if a same source node is connected to different target nodes at the same time, the aggregation function takes an average value of all message values;
if a same source node is connected to a same target node at different times, the aggregation function retains only a message value of a given node at a latest moment; or
if a same source node is connected to different target nodes at different times, the aggregation function is set to an average value of all message values.

5. The APT detection method based on a CDHGN according to claim 1, wherein a method for training the CDHGN decoder comprises: inputting an embedding representation of each type of edge, performing sample labeling on the embedding representation of each type of edge to obtain a sample label, and performing supervised training on the CDHGN encoder and the CDHGN decoder to determine whether an embedding representation of an edge between a source node and a target node at a time point is abnormal.

6. The APT detection method based on a CDHGN according to claim 1, wherein the CDHGN decoder uses a binary cross-entropy loss function and is defined as:
L(\tilde{y}ᵢ(t),yᵢ(t))=−(yᵢ(t)· log(\tilde{y}ᵢ(t))+(1−yᵢ(t))· log(1− [symbol] (t))), wherein
\tilde{y}ᵢ(t) represents a result of determining that an i^{th} edge at a moment t output by the CDHGN decoder is abnormal, and y; (t) represents a sample label value corresponding to the i^{th} edge.

7. An APT detection system based on a CDHGN, comprising a graph constructing module, a network encoder, and a network decoder, wherein
the graph constructing module is configured to: select network interaction event data in a specified time period, extract entities from the network interaction event data as source nodes and target nodes, extract an interaction event occurring between a source node and a target node as an edge, and determine a type and an attribute of a node, a type and an attribute of the edge, and a moment at which an interaction event occurs, to obtain a continuous-time dynamic heterogeneous graph;
the network encoder is configured to convert each type of edge in the continuous-time dynamic heterogeneous graph into a vector, to obtain an embedding representation of each type of edge; and
the network decoder is configured to decode the embedding representation of each type of edge in the continuous-time dynamic heterogeneous graph to obtain a detection result of whether each type of edge is an abnormal edge, so as to intercept an APT attack according to the abnormal edge.

8. The APT detection system based on a CDHGN according to claim 7, wherein the system further comprises a training module, and the training module is configured to train the network encoder and the network decoder.

9. The APT detection system based on a CDHGN according to claim 7, wherein the network encoder comprises a node time memory network and a node space attention network; the node time memory network comprises a first message module, a first aggregation module, a memory update module, and a memory fusion module; and the node space attention network comprises an attention module, a second message module, and a second aggregation module, wherein
the first message module is configured to: for each edge in the continuous-time dynamic heterogeneous graph, separately generate, by a message function according to a time interval between a current moment and a previous moment at which an interaction event occurs, an edge connecting a source node to a target node, and embedding representation memories of the source node and the target node at the previous moment at which an interaction event occurs, message values corresponding to each source node and each target node at the current moment at which an interaction event occurs;
the first aggregation module is configured to separately perform, by an aggregation function, message aggregation on message values corresponding to all source nodes and target nodes in a batch at a current moment at which each interaction event occurs, to separately obtain aggregated message values of each source node and each target node at the current moment at which an interaction event occurs;
the memory update module is configured to: after an interaction event occurs between a source node and a target node, update, according to the aggregated message values of each source node and each target node at the current moment at which an interaction event occurs and the embedding representation memories of each source node and each target node at the previous moment at which an interaction event occurs, embedding representation memories of each source node and each target node in the batch at the current moment at which an interaction event occurs;
the memory fusion module is configured to: perform memory fusion on the updated embedding representation memories of each source node and each target node in the batch at the current moment with vector representations with node attributes of each source node and each target node in the batch, to obtain embedding representations that comprise time context information and that are of each source node and each target node in the batch;
the attention module is configured to calculate an attention score of each node according to the embedding representations that comprise time context information and that are of each source node and each target node, an edge between each source node and each target node, a preset node attention weight matrix, and a preset edge attention weight matrix;
the second message module is configured to: extract a multi-head message value of each source node corresponding to a target node by a message transfer function according to a preset edge message weight matrix and a preset node message weight matrix, and concatenate to generate a message vector of each source node; and
the second aggregation module is configured to: aggregate the message vector of each source node according to the attention score of each node, to obtain embedding representations that comprise space context information and that are of each source node and each target node, and transfer the embedding representations that comprise space context information to the target node; and merge an embedding representation that comprises time context information and that is of a source node on each edge and an embedding representation that comprises space context information and that is of a target node, to obtain, according to a type of an edge, an embedding representation that comprises time and space context information and that is of each type of edge.

10. The APT detection system based on a CDHGN according to claim 9, wherein the attention module comprises a plurality of connected heterogeneous graph convolution layers and linear transformation layers connected after the plurality of heterogeneous graph convolution layers; and
the attention module calculates an attention score of each node, and is specifically configured to:
concatenate embedding representations of a target node and an edge at a previous heterogeneous graph convolution layer to generate a vector dstₑ, wherein dstₑ is denoted as:
$${dst}_{e} = {H}^{( l - 1 )} [ d st ] ‖ {H}^{( l - 1 )} [ e ] ;$$
concatenate embedding representations of a source node and the edge at the previous heterogeneous graph convolution layer to generate a vector srcₑ, wherein srcₑ is denoted as:
srcₑ=H^{(l-1)}[src]∥H^{(l-1)}[e], wherein
l is a layer number of a current heterogeneous graph convolution layer; H^{(l-1)}[src] represents an embedding representation of the source node at an (l−1)^{th} heterogeneous graph convolution layer; H^{(l-1)}[e] represents an embedding representation of the edge at the (l−1)^{th} heterogeneous graph convolution layer; and H^{(l-1)}[dst] represents an embedding representation of the target node at the (l−1)^{th} heterogeneous graph convolution layer;
map the vector dstₑ and the vector srcₑ to a d^{th} Key vector K^{d}(srcₑ) and a d^{th} Query vector Q^{d}(dstₑ) by linear transformation layers K-linear-node^{d} and Q-linear-node^{d};
assign one independent node attention weight matrix Wₙ^{ATT} to different node types, and assign one independent edge attention weight matrix Wₑ^{ATT} to different edge types;
for a d^{th} attention head, calculate an attention score A_{head}^{d}(src, e, dst) of the d^{th} attention head of the source node based on the d^{th} Key vector K^{d}(srcₑ), the d^{th} Query vector Q^{d}(dstₑ), the node attention weight matrix Wₙ^{ATT}, and the edge attention weight matrix Wₑ^{ATT}, wherein A_{head}^{d}(src, e, dst), K^{d}(srcₑ), and Q^{d}(dstₑ) are denoted as:
$${A}_{head}^{d} ( src , e , dst ) = \frac{( {K}^{d} ( {src}_{e} ) ( {W}_{e}^{A T T} + {W}_{n}^{A T T} ) {Q}^{d} ( {dst}_{e} ) )}{\sqrt{d}} ;$$
$${K}^{d} ( s r {c}_{e} ) = K - linear - {node}^{d} ( {H}^{( l - 1 )} [ src ] \vert \vert {H}^{( l - 1 )} [ e ] ) ; and$$
$${Q}^{d} ( d s {t}_{e} ) = Q - linear - {node}^{d} ( {H}^{( l - 1 )} [ dst ] \vert \vert {H}^{( l - 1 )} [ e ] ) ; and$$
concatenate and perform normalization on attention scores of all m attention heads to obtain a final attention score Attention (src, e, dst) between the source node and the target node at the current heterogeneous graph convolution layer, wherein Attention (src, e, dst) is denoted as:
$$Attention ( src , e , d s t ) = \begin{matrix}Softmax \\ ∀ src ∈ N ( dst )\end{matrix} ( {‖}_{d ∈ [ 1 , m ]} {A}_{head}^{d} ( src , e , dst ) ) ,$$
wherein
N(dst) is all neighboring nodes of a target node, src represents a source node, and dst represents a target node; and e represents an edge connecting a source node to a target node.

11. The APT detection system based on a CDHGN according to claim 10, wherein the second message module is configured to perform the following steps:
when the attention score at the current heterogeneous graph convolution layer is calculated, for the d^{th} attention head, performing, by a linear transformation layer V-linear-node^{d}, linear mapping on the vector srcₑ generated through concatenating the embedding representations of the source node and the edge at the previous heterogeneous graph convolution layer, wherein srcₑ is denoted as srcₑ=H^{(l-1)}[src]∥H^{(l-1)}[e];
assigning one independent node message weight matrix Wₙ^{MSG} to different node types, and assigning one independent edge message weight matrix Wₑ^{MSG} to different edge types;
for the d^{th} attention head, generating a message vector M_{head}^{d} of the d^{th} attention head according to the vector srcₑ obtained through linear transformation by the linear transformation layer V-linear-node^{d}, the node message weight matrix Wₙ^{MSG}, and the corresponding edge message weight matrix Wₑ^{MSG}, wherein M_{head}^{d} is denoted as:
M_{head}^{d}=V-linear-node^{d}(H^{(l-1)}[src]∥H^{(l-1)}[e])(Wₑ^{MSG}+Wₙ^{MSG}); and
concatenating message vectors of all the m attention heads to obtain a final message value of the source node at the current l^{th} heterogeneous graph convolution layer, wherein the message value is denoted as:
$$Message ( src , e , dst ) = {‖}_{d ∈ [ 1 , m ]} {M}_{h e a d}^{d} .$$
